(19) United States
(12) Patent Application Publication
(10) Pub. No.: US 2013/0042738 A1
(43) Pub. Date: Feb. 21, 2013

(54) KNIFE HOLDER FOR UNDERWATER CUTTING PELLETIZING DEVICE

(71) Applicants: Shin Iwasaki, Takasago-shi (JP); Kazuo Iritani, Takasago-shi (JP); Yoshiaki Nakata, Takasago-shi (JP)

(72) Inventors: Shin Iwasaki, Takasago-shi (JP); Kazuo Iritani, Takasago-shi (JP); Yoshiaki Nakata, Takasago-shi (JP)

(73) Assignee: KABUSHIKI KAISHA KOBE SEIKO SHO (Kobe Steel, Ltd.), Kobe-shi, Hyogo (JP)

(21) Appl. No.: 13/695,545

(22) PCT Filed: Jun. 3, 2011
(86) PCT No.: PCT/JP2011/003142

§ 371 Date: Oct. 31, 2012

(30) Foreign Application Priority Data
Jun. 7, 2010 (JP) 2010-129957

(51) Int. Cl. B29B 9/06

(52) U.S. Cl. 83/673

(57) ABSTRACT

Provided is a knife holder (10) for use with an underwater cutting pelletizing device which includes a die plate (40) and the knife holder (10). The die plate (40) includes an annular projected portion (52) and a plurality of die holes (51) having an opening on the projected portion (52). The knife holder (10) holds a plurality of knives (30) which slide on the surface of the projected portion (52) to thereby cut melt resin, which has been pushed through each of the die holes (51), into resin pellets in cooling water. The knife holder (10) can reduce the deflection of the knife (30) and thereby the gap that appears between the sliding plane thereof and the die plate projected portion (52). The knife holder (10) includes a knife holder body (11) and a plurality of rib portions (12). The knife holder body (11) has an outer circumference end (11a) which is located inside the inner circumference end of the projected portion (52) of the die plate (40) in the radial direction. The rib portions (12) are provided at respective multiple positions that are arranged in the circumferential direction of the outer circumference end (11a); are projected radially outwardly from the outer circumference end (11a) to extend outwardly past the inner circumference end of the projected portion (52); and have a front face located above the die plate and have the knife (30) secured thereto with the back face of the knife (30) facing the front face.

### TECHNICAL FIELD

The present invention relates to knife holders provided in underwater cutting pelletizing devices that manufacture thermoplastic resin pellets.

### BACKGROUND ART

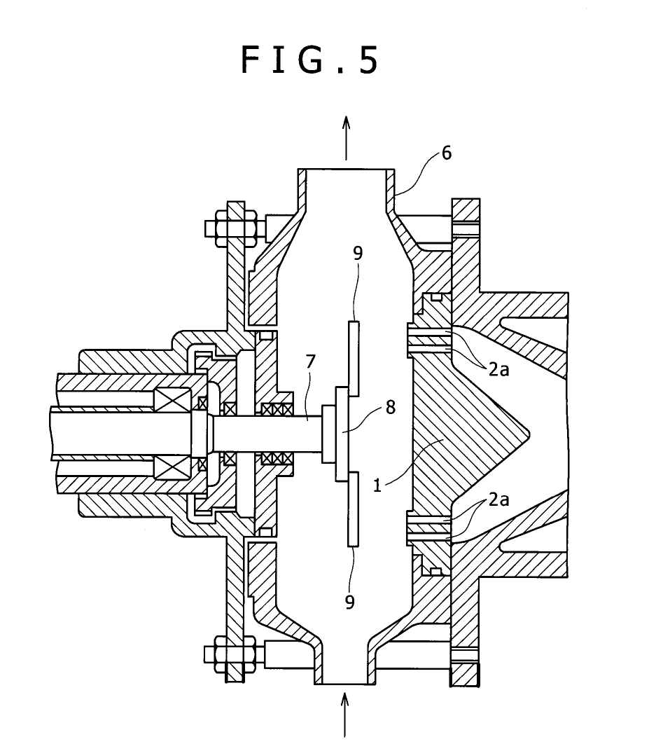

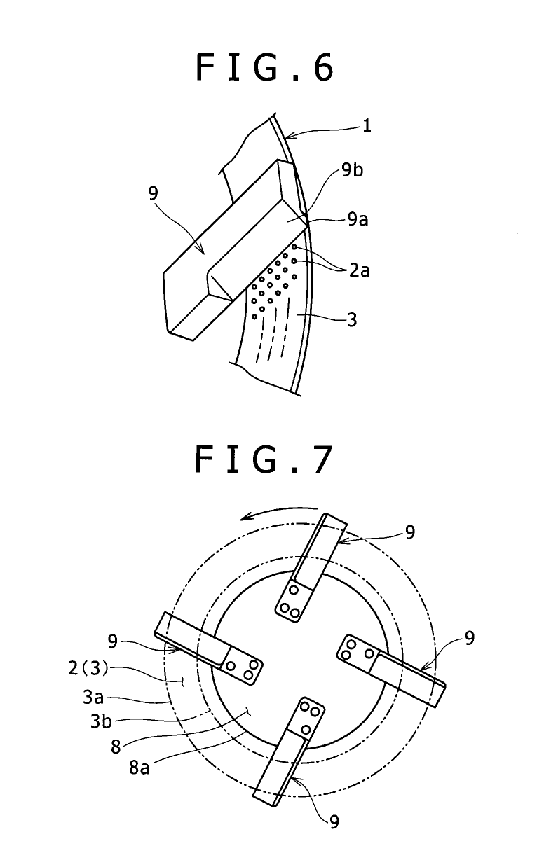

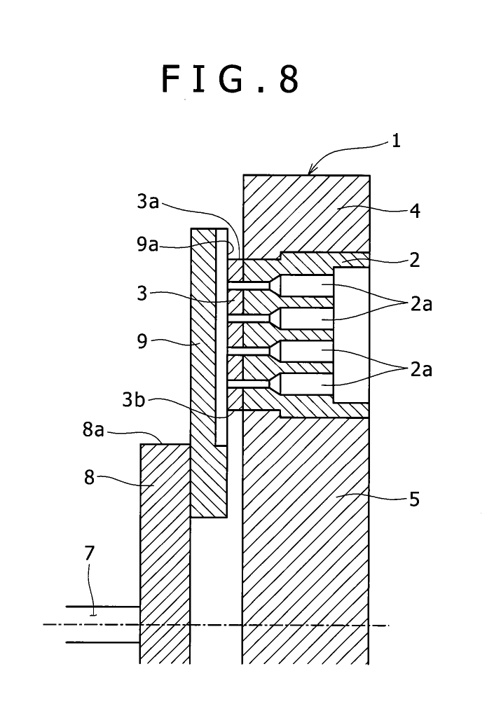

Devices such as that disclosed in Japanese Utility Model Laid-Open No. H7-40112 (a first conventional example) are known as conventional underwater cutting pelletizing devices. FIG. 5 is a side cross-sectional view illustrating an underwater cutting pelletizing device provided with a knife holder for an underwater cutting pelletizing device according to the stated first conventional example, FIG. 6 is a perspective view of a projected portion of a die plate and a knife in the stated pelletizing device, FIG. 7 is a rear view of the knife and a knife holder that holds the knife, and FIG. 8 is a cross-sectional view illustrating the knife holder, the knife, and the die plate illustrated in FIG. 5.

As shown in FIG. 5, this underwater cutting pelletizing device includes: a die plate 1, attached to the leading end portion of an extrusion barrel in a mixer/extruder, that has a die portion 2 (see FIG. 8) in which a plurality of die holes 2a are formed; a water chamber 6 that forms a water compartment that is filled with cooling water and in which the cooling water (warm water, at approximately 60° C.) circulates; a rotating shaft 7 that protrudes into the water chamber 6; a knife driving unit that rotates the rotating shaft 7; a knife holder 8 anchored to the leading end portion of the rotating shaft 7; and a plurality of knives (cutter knives) 9 held by the knife holder 8 so as to face to the die portion 2.

The die plate 1 has a circular plate shape (disk shape) that is thick overall. To be more specific, as shown in FIGS. 7 and 8, the die plate 1 includes the die portion 2 that has a circular ring shape, an outer circumference portion 4 that has a circular ring shape and that is disposed on the outside of the die portion 2, and a center portion 5 that has a disk shape and that is disposed on the inside of the die portion 2. The plurality of die holes 2a, for extruding a thermoplastic resin supplied to the mixer/extruder and mixed by a screw thereof into strands, are formed in an inner portion of the die portion 2. A hardened layer (for example, a TiC hardened layer) is formed on the entire surface of the die portion 2, and as a result, a projected portion 3 that projects further toward the knives 9 than the other portions is formed.

The knives 9 are pressed against the surface of the projected portion 3 and rotationally driven integrally with the rotating shaft 7 along the surface of the projected portion 3 (see FIG. 6), and as a result, the strand-shaped thermoplastic resin that has been extruded from the plurality of die holes 2a is cut into pellets by the knives 9. This realizes underwater pelletizing for thermoplastic resin.

The knives 9 have rectangle shapes that extend in one direction when viewed from the front (or the rear) as shown in FIG. 7; and as shown in FIG. 6, each of the knives 9 has a sliding surface 9a that rotates while it is pressed against the projected portion 3 of the die plate 1 so as to slide along the surface of the projected portion 3, and a cutting face 9b that forms a face angle of the knife. In this example, four knives 9 are supported by one end on the front face of the knife holder 8 (that is, the surface that faces the die plate 1) with a circular plate-shape by using bolts to tighten the base end portions of the knives (that is, one end portion of each knife) onto an outer circumference area of the holder in positions arranged at equal intervals in the circumferential direction.

The dimension of the outer diameter of the knife holder 8 is set so that, as shown in FIGS. 7 and 8, a holder outer circumference end 8a is positioned further inward of an inside circumference end 3b of the projected portion 3 in the die plate 1. The reason for this is that, if the outer diameter dimension of the knife holder 8 is increased so that the outer circumference end 8a of the knife holder 8 is located further outside than the inside circumference end 3b of the projected portion 3, the projected portion 3 will be covered by the knife holder 8 from above when the knives 9 rotate, and as a result, it is highly likely that the resin pellets cut by the knives 9 will become caught in the gap between the projected portion 3 and the front face of the knife holder 8, which in turn can result in a breakdown in the shape of the resin pellets.

As described earlier, each of the knives 9 is pushed against the projected portion 3 while being supported on one end by the knife holder 8; accordingly, although the sliding surfaces 9a of the knives 9 make contact with the surface of the projected portion 3 at a position of the knives 9 that is near the knife holder 8, the knives 9 experience more warping toward the free ends of the knives 9 away from the knife holder 8, and thus the gap between the sliding surfaces 9a and the projected portion 3 increases. This inhibits the manufacture of resin pellets having a good cylindrical shape, and may result in tail pellets in which strand-shape entities of approximately 2-3 mm stick to the cut surface, fines, which are strand-shaped entities shredded from the tail pellets, and so on.

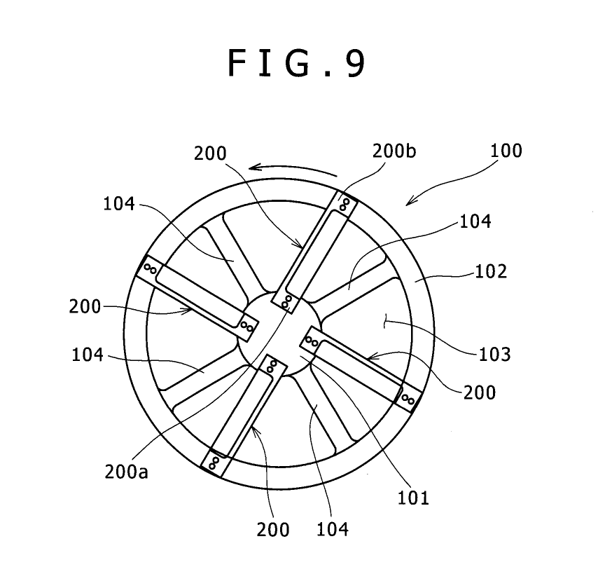

A knife holder for an underwater cutting pelletizing device capable of suppressing such warping in knives is proposed in Japanese Patent Application Laid-Open No. H11-165316 (a second conventional example). FIG. 9 is a front view illustrating a knife holder 100 for an underwater cutting pelletizing device according to the second conventional example. This knife holder 100 holds four knives 200, and includes: a circular plate portion 103 that is rotationally driven along with a rotating shaft, an inner holder portion 101 and an outer holder portion 102 that protrude from the circular plate portion 103 and rotate integrally with the circular plate portion 103, and four ribs 104. The inner holder portion 101 has a circular shape with a small diameter, and an attachment portion 200a, to which one end of each of the knives 200 is attached, is anchored thereto with a bolt. The outer holder portion 102 has a circular ring shape with an inner diameter that is larger than the diameter of the inner holder portion 101, and an attachment portion 200b, on which the other end of each of the knives 200 is provided, is anchored thereto with a bolt. Each of the ribs 104 connects the inner holder portion 101 and the outer holder portion 102 in the radial direction thereof.

In this manner, with the knife holder 100, the attachment portion 200a on one end of each of the knives 200 is attached to the inner holder portion 101, and the attachment portion 200b on the other end is attached to the outer holder portion 102, respectively; and as a result, each of the knives 200 is supported on both ends and warping in the knives 200 is reduced, which in turn makes it possible to reduce the gaps between the projected portion of the die plate and the sliding surfaces of the knives.

However, with the knife holder 100 according to the second conventional example, there is a risk of resin pellets that have been cut accumulating in a space formed between the ribs 104 and the knives 200, or making contact with the ribs 104 which are rotating at a high speed to be deformed as a result.

### CITATION LIST

### Patent Document

Patent Document 1: Japanese Utility Model Laid-Open No. H7-40112
Patent Document 2: Japanese Patent Application Laid-Open No. H11-165316

### SUMMARY OF INVENTION

It is an object of the present invention to provide a knife holder that holds a knife used in an underwater cutting pelletizing device and is capable of reducing a gap between a sliding surface of the knife and a projected portion of a die plate in the pelletizing device by reducing warping of the knife, so as to enable the manufacture of resin pellets having a favorable shape.

A knife holder provided by the present invention is used as a knife holder for an underwater cutting pelletizing device, the underwater cutting pelletizing device including a rotating shaft; a die plate that is anchored to the rotating shaft and has a ring-shaped projected portion that projects further in a direction parallel to the rotating shaft than the other portions, in which a plurality of die holes are formed in the projected portion and a melt resin is extruded from each of the die holes; and the knife holder that holds a plurality of knives that slide along a surface of the projected portion and cut the melt resin extruded from each of the die holes within a cooling water in order to create resin pellets. This knife holder includes: a knife holder body having an outer circumference end positioned further inward in the radial direction of an inner circumference end of the projected portion of the die plate; and a plurality of rib portions, each of which is provided in a respective plurality of positions arranged in the circumferential direction of the outer circumference end of the knife holder body, that protrude outward in the radial direction from the outer circumference end and extend further outward of the inner circumference end of the projected portion, and to which the knives are anchored in a state in which back faces of the knives face front faces of the rib portions that face the die plate.

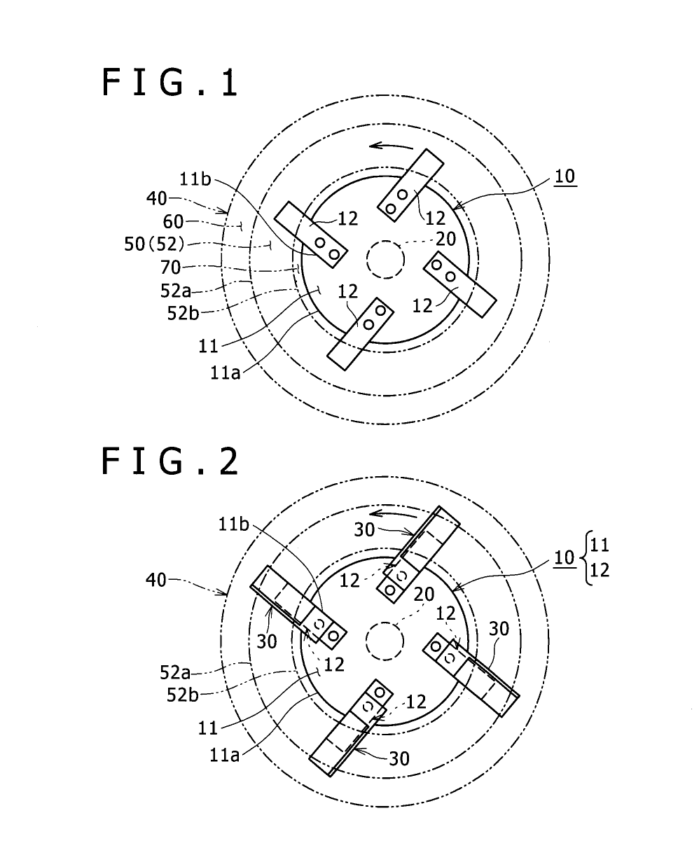

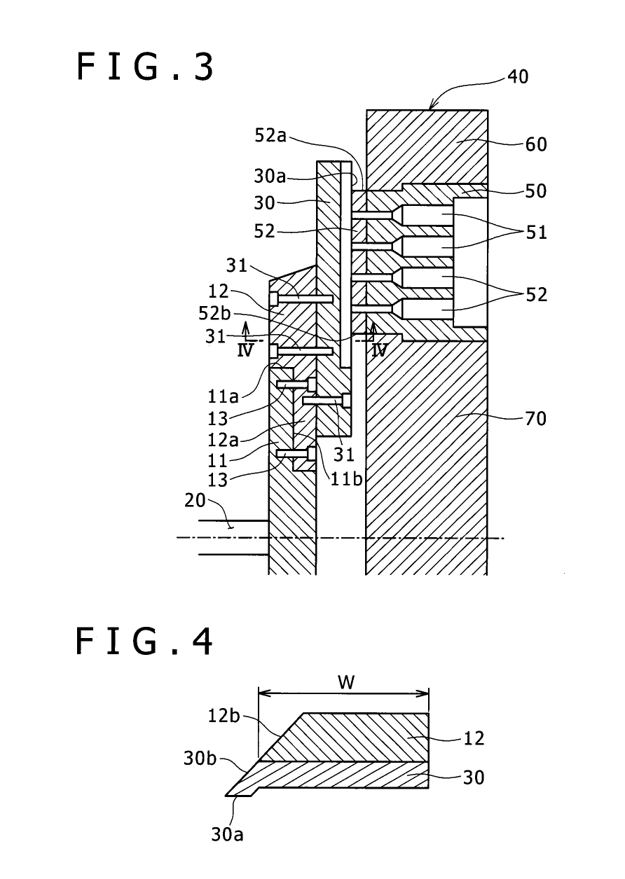

### BRIEF DESCRIPTION OF DRAWINGS

[FIG. 1] A rear view of a knife holder for an underwater cutting pelletizing device according to an embodiment of the present invention.

[FIG. 2] A rear view illustrating the knife holder for the underwater cutting pelletizing device shown in FIG. 1 in a state in which knives are mounted thereon.

[FIG. 3] A cross-sectional view of the elements shown in FIG. 2.

[FIG. 4] A cross-sectional view taken along the IV-IV line shown in FIG. 3.

[FIG. 5] A side cross-sectional view illustrating an underwater cutting pelletizing device provided with a knife holder for an underwater cutting pelletizing device according to a first conventional example.

[FIG. 6] A perspective view of a projected portion of a die plate and knives shown in FIG. 5.

[FIG. 7] A rear view of the knife holder and knives shown in FIG. 5.

[FIG. 8] A cross-sectional view of the knife holder, knives, and die plate shown in FIG. 5.

[FIG. 9] A front view illustrating a knife holder for an underwater cutting pelletizing device according to a second conventional example.

### DESCRIPTION OF EMBODIMENTS

Hereinafter, embodiments of the present invention will be described with reference to the drawings. FIG. 1 is a rear view of a knife holder for an underwater cutting pelletizing device according to an embodiment of the present invention, FIG. 2 is a rear view illustrating the knife holder for the underwater cutting pelletizing device shown in FIG. 1 in a state in which knives are mounted thereon, and FIG. 3 is a cross-sectional view of the elements shown in FIG. 2.

The underwater cutting pelletizing device illustrated in FIGS. 1 through 3 includes: a knife holder 10 for an underwater cutting pelletizing device (also called simply a “knife holder” hereinafter), a plurality of knives 30 held by the knife holder 10, a rotating shaft 20, and a die plate 40 having a circular plate shape.

The die plate 40 is configured by a die portion 50 having a circular ring shape, an outer circumference portion 60 that has a circular ring shape and is disposed on the outer side of the die portion 50, and a center portion 70 that has a circular plate shape or a circular ring shape and that is disposed on the inner side of the die portion 50. A plurality of bolt holes are provided in the outer circumference portion 60 and the center portion 70, respectively, and the die plate 40 is anchored to a die holder by bolts that are inserted through the respective bolt holes. As shown in FIG. 3, a plurality of die holes 51 are formed in the die portion 50, extending in the thickness direction thereof. A hardened layer (for example, a TiC hardened layer) is formed on a surface of the die portion 50, which forms, across the entire surface of the die portion 50, a projected portion 52 that projects further toward the knives 30 than the other surface than the die portion 50, or in other words, a surface of the outer circumference portion 60 and a surface of the center portion 70; and the die holes 51 are provided in this projected portion 52. The surface of the projected portion 52 configures a sliding surface, which is a plane along which the knives 30 are capable of sliding.

The knife holder 10 includes a knife holder body 11 configured by, for example, stainless steel, and a plurality of rib portions 12 configured by, for example, stainless steel; and in this embodiment, four rib portions 12 are provided.

The knife holder body 11 is anchored to a leading end portion of the rotating shaft 20, has a circular plate shape or a disk shape having a circular outer circumference end 11a, and has an outer diameter of a size that positions the outer circumference end 11a further inside than an inner circumference end 52b of the projected portion 52. The knives 30 are held by the knife holder 10 so that base end portions of the knives 30 are positioned further inward of the outer circumference end 11a of the knife holder body 11, when viewed in the radial direction. In other words, the outer circumference end 11a of the knife holder body 11 is positioned further outward of the base ends of the knives 30, when viewed in the radial direction.

The knife holder body 11 has a front face that is a surface facing the die plate 40, and rib attachment grooves 11b to which the rib portions 12 are attached are formed in this front face. Each of the rib attachment grooves 11b is provided in a respective plurality of positions in an outer circumference area of the knife holder body 11, which are arranged at equal intervals in the circumferential direction; and in this embodiment, four rib attachment grooves 11b are provided.

The rib portions 12 have rectangular shapes when viewed from the front or the rear, as shown in FIG. 1. As shown in FIG. 3, a leading end portion, or in other words, a portion on an outer side of the knife holder 10 in the radial direction thereof, of each of the rib portions 12, has the same thickness as that of the knife holder body 11, whereas a base end portion, or in other words, a portion on an inner side of the knife holder 10 in the radial direction thereof, of each of the rib portions 12, has an attachment portion 12a having a thickness that has been reduced to the same dimension as the groove depth of the rib attachment grooves 11b. Each of the attachment portions 12a has a shape that enables fitting into the corresponding rib attachment groove 11b, and when fitted therein, is anchored in a removable state to the knife holder body 11 using a bolt 13. Each of the rib portions 12 has a length such that, in the attached state, protrudes further outward of the outer circumference end 11a of the knife holder body 11 in the radial direction, and extends to a position that is further outward of the inner circumference end 52b of the projected portion 52; and in this embodiment, this position is between the inner circumference end 52b and an outer circumference end 52a of the projected portion 52.

The knives 30 are anchored to the knife holder body 11 or the rib portions 12, in a state in which the back faces of the knives 30 are positioned on the front face of the knife holder body 11 or the rib portions 12. In the present embodiment, each of the knives 30 is anchored to a corresponding rib portion 12 using a bolt 31.

FIG. 4 is a cross-sectional view taken along the IV-IV line shown in FIG. 3. Each of the knives 30 has a rectangular shape that extends in one direction when viewed from the front or the rear, and as shown in FIG. 4, has a sliding surface 30a that is pressed against and slides upon the projected portion 52 of the die portion 50, and a cutting face 30b that forms a face angle of the knife. As shown in FIG. 4, each of the rib portions 12 has a sloped surface 12b having the same angle of slope as an angle of slope of the cutting face 30b of the corresponding knife 30 thereof so as to be continuous with the cutting face 30b. In addition, it is preferable for each of the rib portions 12 to have a width that is less than or equal to a width W of the back face of the corresponding knife 30, and in this embodiment, as shown in FIG. 4, the maximum width dimension of the rib portion 12 matches the dimension of the back face width W of the knife 30. Here, the “back face” of the knife 30 refers to the surface that corresponds to a portion that is continuous with the cutting face 30b of the knife 30 at the following end of the rotational direction, as shown in FIG. 4; and the width W of the back face, meanwhile, refers to the dimension of the back face in the longitudinal direction of the knife 30.

In addition, in this embodiment, the knives 30 are anchored to the rib portions 12 in a state extending along the direction in which the corresponding rib portions 12 extend from the knife holder body 11. This makes it possible for each of the rib portions 12 to efficiently support the corresponding knife 30 with a small surface area.

In this manner, the knife holder 10 for the underwater cutting pelletizing device according to the present embodiment includes the knife holder body 11 and the plurality of rib portions 12 to which the knives 30 are respectively anchored; in which the knife holder body 11 has the outer circumference end 11a located further inward of the inner circumference end 52b of the projected portion 52 of the die plate 40, and each of the rib portions 12 is provided in a respective plurality of positions arranged at equal intervals in the circumferential direction of the outer circumference end 11a of the knife holder body 11 and protrude outward in the radial direction from the outer circumference end 11a so as to extend further outward of the inner circumference end 52b of the projected portion 52. In other words, the back faces of the knives 30 are anchored to the rib portions 12 in tight contact with the front face of the rib portions 12. Accordingly, the knife holder 10 can reduce the gap between the sliding surfaces 30a of the knives 30 and the projected portion 52 of the die plate 40 compared to the conventional knife holder by reducing warping of the knives 30, though the knives 30 are supported on one end; and accordingly, it is possible to manufacture resin pellets having a favorable shape without tail pellets, fines, and so on.

In addition, the rib portions 12 according to this embodiment have the sloped surfaces 12b having the same angle of slope as an angle of slope of the cutting faces 30b of the knives 30 so as to be continuous with the cutting faces 30b, and the maximum width dimension of the rib portions 12 is less than or equal to the dimension of the back face width W of the knives 30; and accordingly, the resin pellets cut by the knives 30 are not interfered with by the rib portions 12 and do not accumulate, so that the cut resin pellets are smoothly transported from the water chamber of the underwater cutting pelletizing device to the next stage by PCW (pellet cooling water).

In the aforementioned embodiment, the rib portions 12 protrude outward in the radial direction from the outer circumference end 11a of the knife holder body 11 and have a length that extends to the vicinity of a central area between the inner circumference end 52b and the outer circumference end 52a of the projected portion 52; however, the rib portions 12 may have a length that extends to a position of the outer circumference end 52a of the projected portion 52, or to a position further outward in the radial direction therefrom. The rib portions 12 that have such a length can support the knives 30 across a wider region, which makes it possible to further reduce warping of the knives 30.

In the aforementioned embodiment, the knife holder body 11 and the rib portions 12 are separate members that are tightened onto each other using bolts, but may be formed as an integral component using a shaving process or welding.

As described thus far, the present invention provides a holder that holds a knife used in an underwater cutting pelletizing device and is capable of reducing a gap between a sliding surface of the knife and a projected portion of a die plate in the pelletizing device by reducing warping of the knife, so as to enable the manufacture of resin pellets having a favorable shape.

Specifically, the present invention provides a knife holder for an underwater cutting pelletizing device, the underwater cutting pelletizing device including a rotating shaft; a die plate that is anchored to the rotating shaft and has a ring-shaped projected portion that projects further in a direction parallel to the rotating shaft than the other portions, in which a plurality of die holes are formed in the projected portion and a melt resin is extruded from each of the die holes; and the knife holder that holds a plurality of knives that slide along a surface of the projected portion and cut the melt resin extruded from each of the die holes within a cooling water in order to create resin pellets. This knife holder includes: a knife holder body having an outer circumference end positioned further inward in the radial direction of an inner circumference end of the projected portion of the die plate; and a plurality of rib portions, each of which is provided in a respective plurality of positions arranged in the circumferential direction (preferably, at equal intervals) of the outer circumference end of the knife holder body, that protrude outward in the radial direction from the outer circumference end and extend further outward of the inner circumference end of the projected portion, and to which the knives are anchored in a state in which back faces of the knives face front faces of the rib portions that face the die plate.

This knife holder can reduce a gap between the sliding surfaces of the knives and the surface of the projected portion of the die plate compared to the conventional knife holder by reducing warping of the knives, though each of the knives is supported on one end; and accordingly, it is possible to manufacture resin pellets having a favorable shape without tail pellets, fines, and so on.

It is further preferable for each of the rib portions to have a sloped surface having the same angle of slope as an angle of slope of a cutting face of the corresponding knife thereof so as to be continuous with the cutting face, and for the rib portions to have a width dimension that is less than or equal to the width of the back faces of the knives. The rib portions having such a shape do not interfere with the resin pellets cut by the knives and do not cause the resin pellets to accumulate, so as to permit the cut resin pellets to be smoothly transported from the water chamber of the underwater cutting pelletizing device to the next stage by PCW (pellet cooling water).

It is further preferable for the rib portions to protrude outward in the radial direction from the outer circumference end of the knife holder body and to have a length that extends to a position of the outer circumference end of the projected portion or to a position that is further outward in the radial direction therefrom. The rib portions that have such a length can support the knives across a longer region, which makes it possible to further reduce warping of the knives.

It is further preferable for the knife corresponding to each of the rib portions to be anchored to the rib portion in a state extending along the direction in which the rib portion extends from the knife holder body. This makes it possible for each of the rib portions to efficiently support the corresponding knife with a small surface area.

1. A knife holder for an underwater cutting pelletizing device, the underwater cutting pelletizing device including a rotating shaft; a die plate that is anchored to the rotating shaft and has a ring-shaped projected portion that projects further in a direction parallel to the rotating shaft than the other portions, in which a plurality of die holes are formed in the projected portion and a melt resin is extruded from each of the die holes; and the knife holder that holds a plurality of knives that slide along a surface of the projected portion and cut the melt resin extruded from each of the die holes within a cooling water in order to create resin pellets, the knife holder comprising:
a knife holder body having an outer circumference end positioned further inward in the radial direction of an inner circumference end of the projected portion of the die plate; and
a plurality of rib portions, each of which is provided in a respective plurality of positions arranged in the circumferential direction of the outer circumference end of the knife holder body, that protrude outward in the radial direction from the outer circumference end and extend further outward of the inner circumference end of the projected portion, and to which the knives are anchored in a state in which back faces of the knives face front faces of the rib portions that face the die plate.

2. The knife holder for the underwater cutting pelletizing device according to claim 1,
wherein each of the rib portions has a sloped surface having the same angle of slope as an angle of slope of a cutting face of the corresponding knife thereof so as to be continuous with the cutting face, and the rib portions have a width dimension that is less than or equal to the width of the back faces of the knives.

3. The knife holder for the underwater cutting pelletizing device according to claim 1,
wherein the rib portions protrude outward in the radial direction from the outer circumference end of the knife holder body and have a length that extends to the position of the outer circumference end of the projected portion or to a position that is further outward in the radial direction therefrom.

4. The knife holder for the underwater cutting pelletizing device according to claim 1,
wherein the knife corresponding to each of the rib portions is anchored to the rib portion in a state extending along the direction in which the rib portion extends from the knife holder body.
